(19) United States
(12) Patent Application Publication
(10) Pub. No.: US 2014/0283794 A1
(43) Pub. Date: Sep. 25, 2014

(54) Pressure control valve for gaseous fuel

(71) Applicant: DENSO CORPORATION, Kariya-city (JP)

(72) Inventors: Akira Takagi, Obu-city (JP); Makoto Kondo, Miyoshi-city (JP); Yuichi Takemura, Toyohashi-city (JP)

(21) Appl. No.: 14/097,700

(22) Filed: Dec. 5, 2013

(30) Foreign Application Priority Data
Dec. 5, 2012 (JP) 2012-266305

(51) Int. Cl. F02M 25/08

(52) U.S. Cl. CPC F02M 25/0836
USPC 123/520

(57) ABSTRACT

A pressure control valve controls a pressure of a gaseous fuel according to an engine operation state. The pressure control valve has a movable valve body, a manifold chamber that communicates with an intake manifold, and a passage that is connected to an injector. An intake manifold pressure from the manifold chamber moves the movable valve body in a valve opening direction and an output pressure from the passage moves the movable valve body in a valve closing direction. In such manner, the pressure control valve changes a magnitude of a differential pressure between the output pressure and the intake manifold pressure according to a magnitude of the intake manifold pressure.

### CROSS REFERENCE TO RELATED APPLICATION

The present application is based on and claims the benefit of priority of Japanese Patent Application No. 2012-266305, filed on Dec. 5, 2012, the disclosure of which is incorporated herein by reference.

### FIELD OF THE INVENTION

The present disclosure generally relates to a pressure control valve for controlling a pressure of a gaseous fuel.

### BACKGROUND INFORMATION

Generally, a gaseous fuel supply system that is used to supply gaseous fuel to an internal-combustion engine (hereinafter “engine”) may include a pressure control valve for reducing a pressure of the gaseous fuel that is stored in a fuel tank. The pressure of the gaseous fuel in the fuel tank is reduced by using an injector to inject the gaseous fuel into the engine. For example, a patent document 1 (i.e., Japanese Patent Laid-Open No. 2005-004553) discloses a pressure reducing valve that has a valve body to which a pressure of the gaseous fuel to be supplied to the injector (hereinafter “output pressure”) is applied. As such, a relative position of such valve body with respect to a valve seat is changed according to the output pressure. Further, a patent document 2 (i.e., Japanese Patent Laid-Open No. 2010-515993) discloses a fluid pressure modulator having an electromagnetic actuator which generates an attracting electromagnetic force according to an engine operation state. Similarly, the relative position of the valve body with respect to the valve seat is changed by such an attracting electromagnetic force. Furthermore, a patent document 3 (i.e., Japanese Patent No. 5,013,888) discloses a pressure reducing valve having a diaphragm to which an intake manifold pressure is connected to the engine is applied. The relative position of the valve body, which is connected to the diaphragm, changes with respect to the valve seat so that a differential pressure across the output pressure and the intake manifold pressure has a constant value.

However, in the pressure reducing valve of patent document 1, since the input pressure of the gaseous fuel supplied to a pressure reducing valve from a fuel tank is applied to a valve body, the output pressure of the gaseous fuel may become unstable when controlling a pressure of high-pressure gaseous fuel.

In the fluid pressure modulator in the patent document 2, due to a complex configuration of the electromagnetic actuator, the pressure of the gaseous fuel may become uncontrollable when the electromagnetic actuator malfunctions.

Further, the pressure reducing valve in the patent document 3 has a relatively narrow stable operation area (i.e., a dynamic range), in which a stable correlation is observed between (i) the injection pulse width that is input to an injector to which the pressure reducing valve supplies the gaseous fuel and (ii) an injection amount of the gaseous fuel. Therefore, the pressure reducing valve may not supply a proper amount of the gaseous fuel to the intake manifold when the engine operates at low speed and low load conditions or at high speed and high load conditions.

### SUMMARY

It is an object of the present disclosure to provide a pressure control valve for controlling a pressure of a gaseous fuel according to an operation of an engine.

In an aspect of the present disclosure, the pressure control valve for a gaseous fuel supply system has a fuel tank for storing a gaseous fuel and an injector for injecting the gaseous fuel into an intake manifold that is connected to an internal-combustion engine. The pressure control valve also includes a housing having an inlet port and an outlet port, the inlet port providing the gaseous fuel from the fuel tank and the outlet port providing pressure-controlled gaseous fuel to the injector, a first pressure receiver receiving a pressure provided to the injector, and a second pressure receiver receiving an intake manifold pressure. Further, the pressure control valve includes a movable valve body positioned between the inlet port and the outlet port and biased by a first received force received by the first pressure receiver and a second received force received by the second pressure receiver and a seat member that selectively abuts the movable valve body to open and close communication between the inlet port and the outlet port. As such, the movable valve body changes a differential pressure between the pressure provided to the injector and the intake manifold pressure.

In another aspect of the present disclosure, the pressure control valve for a gaseous fuel supply system has a fuel tank for storing a gaseous fuel and an injector for injecting the gaseous fuel into an intake manifold that is connected to an internal-combustion engine. The pressure control valve also includes a housing having an inlet port and an outlet port, the inlet port providing the gaseous fuel from the fuel tank and the outlet port providing pressure-controlled gaseous fuel to the injector. Further, the pressure control valve includes a movable valve body that is slidably disposed between the inlet port and the outlet port, and selectively provides a communication passage between the inlet port and the outlet port and a seat member that selectively abuts the movable valve body to open and close the communication passage between the inlet port and the outlet port, the seat member that selectively abuts a first end of the movable valve body on a valve seat, and the valve seat having a seat diameter defined as a first diameter. A first biasing member biases the movable valve body in a direction that causes the movable valve body to move away from the seat member. A first seal has a diameter that is equal to the first diameter to maintain airtightness between (i) a first pressure chamber positioned at a first end of the movable valve body, and (ii) a manifold chamber that houses the first biasing member and receives an intake manifold pressure. A supporter is connected to a second end of the movable valve body. The supporter has an outer diameter that is greater than the first diameter and slidably disposed to support a movement of the movable valve body. A partition portion separates an inside of the housing at a position between the supporter and the first seal. The partition portion has an outer diameter that is greater than an outer diameter of the supporter. A second seal is positioned on the supporter and has a seal diameter defined as a second diameter which is greater than the first diameter. A third seal is positioned on the partition portion and has a seal diameter defined as a third diameter which is greater than the second diameter. The second seal maintains airtightness between (i) an atmospheric chamber that communicates with an atmosphere and is defined between the second seal and the third seal, and (ii) the outlet port. Further, the third seal maintains airtightness between the manifold chamber and the atmospheric chamber.

The pressure control valve for controlling a pressure of the gaseous fuel in the present disclosure changes a magnitude of a differential pressure across (i) a pressure of the gaseous fuel to be provided to the injector and (ii) a intake manifold pressure according to a magnitude of the intake manifold pressure, by using the valve body to which the first received force that is a pressure of the gaseous fuel provided to the injector and the second received force that is a intake manifold pressure that is connected to the internal-combustion engine. The first received force and the second received force move the valve body in mutually-opposing directions. In such manner, a gaseous fuel having a controlled pressure that is controlled according to a pressure in the intake manifold is provided to the injector that has a relatively-narrow dynamic range. Therefore, a dynamic range of the gaseous fuel supply system as a whole, including the injector, is enlarged. Thus, the pressure control valve for gaseous fuel according to the present disclosure may accurately control a pressure of the gaseous fuel for (i) a low speed and low load operation of the engine, which is likely to use a relatively small amount of gaseous fuel, and (ii) a high speed and high load operation of the engine, which demands a relatively large amount of the gaseous fuel.

Further, the pressure control valve for gaseous fuel in the present disclosure supplies the gaseous fuel at a suitable pressure to the injector according to a pressure in the intake manifold, without the use of costly or complicated electromagnetic actuators. Therefore, a configuration of the pressure control valve for gaseous fuel is simplified and a size volume of such valve is reduced.

### BRIEF DESCRIPTION OF THE DRAWINGS

Objects, features, and advantages of the present disclosure will become more apparent from the following detailed description made with reference to the accompanying drawings, in which:

FIG. 1 is a configuration diagram of a gaseous fuel supply system to which a pressure control valve for gaseous fuel in a first embodiment of the present disclosure is applied;

FIG. 2 is a sectional view of the pressure control valve for gaseous fuel in the first embodiment of the present disclosure;

FIG. 3 is a sectional view of the pressure control valve for gaseous fuel in the first embodiment of the present disclosure for an explanation of an operation of the valve;

FIG. 4 is a diagram illustrating a relationship between an intake manifold pressure and an output pressure in the pressure control valve for gaseous fuel in the first embodiment of the present disclosure;

FIG. 5 is a sectional view of the pressure control valve for gaseous fuel in a second embodiment of the present disclosure;

FIG. 6 is a sectional view of the pressure control valve for gaseous fuel in a modification in the second embodiment of the present disclosure; and

FIG. 7 is a sectional view of the pressure control valve for gaseous fuel in a third embodiment of the present disclosure.

### DETAILED DESCRIPTION

Embodiments of the present disclosure are described based on the drawings.

### First Embodiment

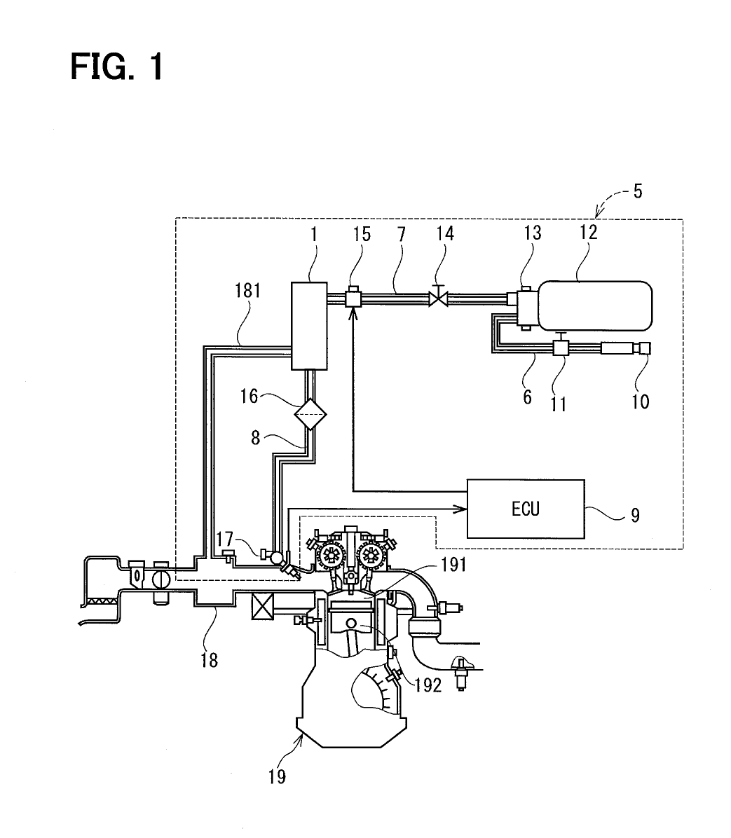

FIG. 1 illustrates a configuration of a gaseous fuel supply system to which the present disclosure is applied. A gaseous fuel supply system 5 may be installed in a vehicle which uses a compressed natural gas for fuel, for example. The gaseous fuel supply system 5 is provided with a fuel filler port 10, a fuel tank 12, a pressure control valve 1, an injector 17, an ECU 9, together with other parts.

The high-pressure gaseous fuel supplied through the fuel filler port 10 from the outside is stored to the fuel tank 12 via a connecting pipe 6. The fuel filler port 10 has a back-flow-prevention function, by which the gaseous fuel supplied from the fuel filler port 10 is prevented from flowing backwards toward an atmosphere. The connecting pipe 6 has a gas-charging valve 11 that is formed thereon.

A fuel tank valve 13 is formed on the fuel tank 12. The fuel tank valve 13 has the back-flow-prevention function that prevents a flow of the gaseous fuel from the fuel tank 12 to the fuel filler port 10, a surplus flow prevention function that interrupts a flow of the gaseous fuel from the fuel tank 12 when the gaseous fuel equal to or greater than a predetermined amount flows through a connecting pipe 7, and a pressure release safety function that releases an internal pressure of the fuel tank 12 to the atmosphere when the internal pressure of the tank 12 increases, for the purpose of preventing an explosion of the tank 12.

The fuel tank valve 13 is connected to the pressure control valve 1 via the connecting pipe 7. The connecting pipe 7 has a root valve 14 which can manually interrupt the connecting pipe 7 according to a manual operation and a main stop valve 15 which can electrically interrupt the connecting pipe 7 according to an electric operation, which are respectively formed thereon.

The pressure control valve 1 reduces a pressure of the gaseous fuel supplied via the connecting pipe 7 (hereinafter “input pressure”) to the pressure level which can be supplied to the injector 17. For example, the pressure control valve 1 reduces the gaseous fuel of 20 MPa in the fuel tank 12 to a pressure range between 0.2 and 0.65 MPa (i.e., a pressure which can be supplied to the injector 17). The pressure control valve 1 can control, in advance, a pressure of the gaseous fuel supplied to the injector 17 (hereinafter “output pressure”) to be within a predetermined range. The pressure control valve 1 is connected to an intake manifold 18 via a connecting pipe 181. Details of the structure of the pressure control valve 1 are described below.

After the reduction of the pressure by the pressure control valve 1, oil is removed from the gaseous fuel with an oil filter 16, which is then supplied to the injector 17 through a connecting pipe 8. The injector 17 injects the gaseous fuel into the intake manifold 18 according to an instruction of an ECU 9 which electrically connect to the injector 17. The injector 17 has a temperature sensor and a pressure sensor formed thereon, which are not illustrated. The information about a temperature and a pressure of the gaseous fuel which are respectively detected by the temperature sensor and the pressure sensor is outputted to the ECU 9. The ECU 9 outputs a signal to the main stop valve 15 for an interruption of the connecting pipe 7 when the pressure of the gaseous fuel supplied to the injector 17 is equal to or greater than a preset value.

The gaseous fuel injected into the intake manifold 18 is mixed with an air introduced from the atmosphere, and is introduced into a cylinder 191 from an intake port of an engine 19 to which the intake manifold 18 is connected. In the engine 19, a rotation torque is generated by a compression and a combustion of a mixed gas that is a mixture of the gaseous fuel and the air, which is caused by a rise of a piston 192.

In such manner, the pressure control valve 1 and the injector 17 of the gaseous fuel supply system 5 reduce a pressure of the high-pressure gaseous fuel to a low pressure by injecting the gaseous fuel with the injector 17 to supply the low-pressure gaseous fuel to the engine 19.

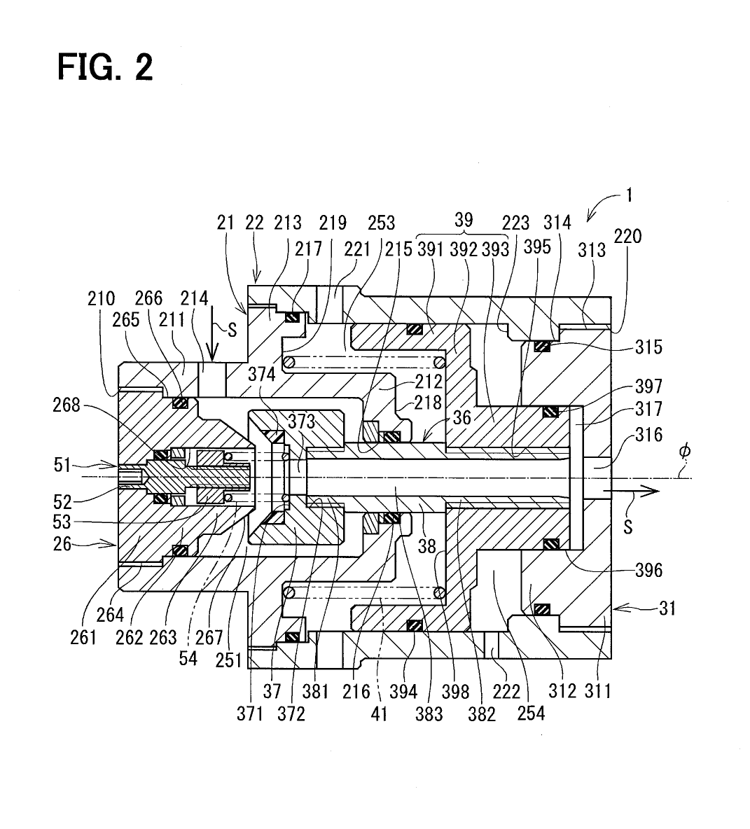

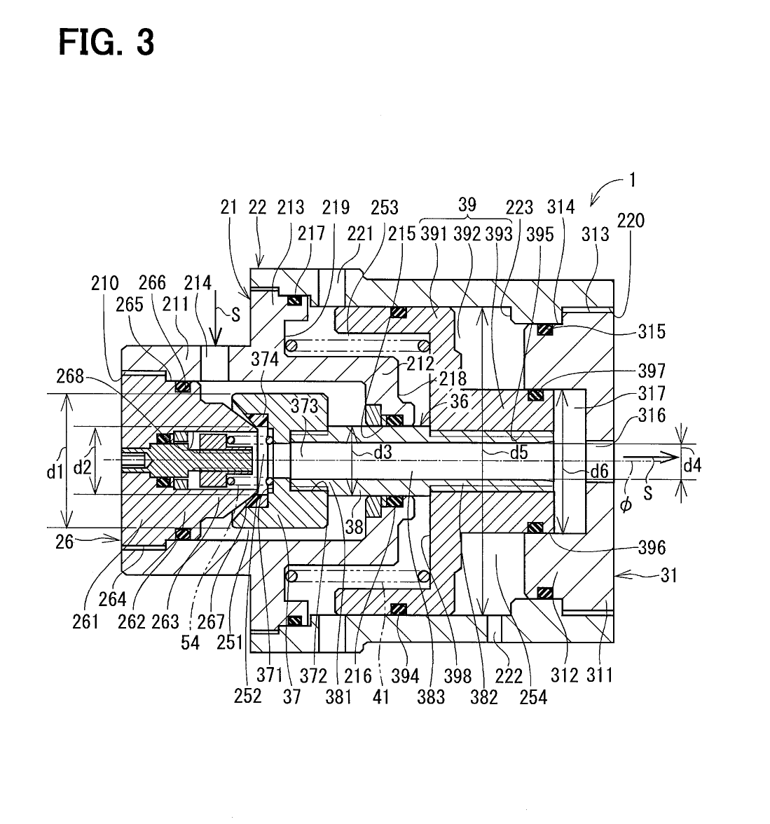

The details of the configuration of the pressure control valve 1 are described based on FIGS. 2 and 3. An arrow S in the drawing illustrates the direction of flow of the gaseous fuel.

The pressure control valve 1 includes a first housing 21, a second housing 22, a first cover 26, a second cover 31, a valve body 36, a sliding part 39, a main spring 41, a biasing force adjuster 51, a sub-spring 54, together with other parts.

The first housing 21 is formed in the shape of a cylinder having a base, which include a cylinder part 211, a bottom 212, and a flange 213, which are combined in a single-body. The first housing 21 defines a first pressure chamber 251 that accommodates a part of the valve body 36. The first housing 21 may be a “housing” in the claims.

The cylinder part 211 has an outlet port 214 that is connected to the connecting pipe 7 (see FIG. 1). The outlet port 214 allows communication between an interior and an exterior of the first housing 21, that is, communication between the first pressure chamber 251 and the connecting pipe 7.

The bottom 212 is connected to a second housing 22 side end of the cylinder part 211. The bottom 212 has, substantially at its center part, a through hole 215 which allows communication between an inside of the first housing 21 and an inside of the second housing 22. An axial part 38 of the valve body 36 is inserted into the through hole 215. A sealing member 216 is disposed on an inner wall of the through hole 215. The sealing member 216 maintains airtightness between the first pressure chamber 251 in the first housing 21 and a third pressure chamber 253 in the second housing 22, for example. The sealing member 216 may be a “first seal” in the claims.

The flange 213 projects in a radial direction away from the cylinder part 211. A sealing member 217 is disposed on a side wall of the flange 213 which is on an outside in the radial direction thereof (i.e., may also be designated “on an “outer perimeter” henceforce). The sealing member 217 maintains airtightness of the third pressure chamber 253 from an outside of the second housing 22.

The second housing 22 is formed in the shape of a cylinder, in which an outer diameter of the second housing 22 is greater than the outer diameter of the first housing 21. The second housing 22 forms, by screwing a threaded groove at an inside of the second housing 22 to a threaded groove on an outside of the flange 213 of the first housing 21, a concave portion having a bottom as a combination of a surface 218 of the bottom 212, a part of an outer wall of the cylinder part 211, and a surface 219 of the flange 213 on a second housing 22 side. The second housing 22 houses, in an inside of the concave part having the bottom, the second cover 31, a part of the valve body 36, the sliding part 39, the main spring 41, and the sub-spring 54. The second housing 22 may be a “housing” in the claims.

The inside of the second housing 22 is divided by the sliding part 39, which is described later, into the third pressure chamber 253, which may be a “manifold chamber” in the claims, and a fourth pressure chamber 254, which may be an “atmospheric chamber” in the claims. More specifically, the third pressure chamber 253 is defined by an outer wall of the sliding part 39, an outer wall of the first housing 21, and an inner wall of the second housing 22. Further, the fourth pressure chamber 254 is defined by an outer wall of the sliding part 39 and by inner walls of the second cover 31 and the second housing 22. The third pressure chamber 253 communicates with the intake manifold 18 of the engine 19 via a communication hole 221 and a connecting pipe 181 (see FIG. 1) which are formed on the second housing 22. The fourth pressure chamber 254 communicates with an outside of the second housing 22, that is, with atmosphere, via a communication hole 222 which is formed on a side wall of the second housing 22.

A stepped surface 223 is formed on the inner wall which defines the fourth pressure chamber 254 of the second housing 22. The stepped surface 223 restricts a movement of the sliding part 39 toward the second cover 31, when assembling the pressure control valve 1. Details of such structure are described later in an assembly procedure of the pressure control valve 1.

The first cover 26 comprises a cylindrical shape large diameter part 261 and a cylindrical shape middle diameter part 262. The diameter of the part 262 is smaller than the diameter of the part 261, and a small diameter part 263 substantially in the shape of a truncated cone. An outer wall 264 on the outer perimeter of the large diameter part 261 has a threaded groove formed thereon. The threaded groove engages with the threaded groove formed on the inner wall of an opening 210 of the cylinder part 211 of the first housing 21. Therefore, the first cover 26 is fixed to an inside of the opening 210 of the first housing 21. A sealing member 266 is disposed on an outer wall 265 of the middle diameter part 262. The sealing member 266 maintains airtightness of the first pressure chamber 251 from an outside of the first housing 21. A conical surface 267 of the small diameter part 263 is formed so that the conical surface 267 abuts the valve body 36. A through hole 268 is bored substantially at the center of the first cover 26. The biasing force adjuster 51 is formed in the through hole 268. The first cover 26 may be a “seat member” in the claims. The conical surface 267 may be a “valve seat” in the claims.

The second cover 31 comprises a cylindrical large diameter part 311, and a ring-shaped small diameter part 312. The outer diameter of the small diameter part 312 is smaller than the outer diameter of the large diameter part 311. An outer wall 313 on an outer diameter of the large diameter part 311 has a threaded groove formed thereon. The threaded groove engages with the threaded groove formed on the inner wall of an opening 220 of the second housing 22. Therefore, the second cover 31 is fixed to an inside of the opening 220 of the second housing 22. A sealing member 315 is disposed on an outer wall 314 of the small diameter part 312. The sealing member 315 maintains airtightness between the fourth pressure chamber 254 and an outside thereof. The second cover 31 may be a “housing” in the claims.

Two passages having respectively different inner diameters are bored substantially at the center of the second cover 31. One of the two passages is a small inner diameter passage 316 having a relatively small inner diameter, and the other of the two passages is a large inner diameter passage 317 having a relatively large inner diameter. The small inner diameter passage 316, which may be an “outlet port” in the claims, is connected to the injector 17 via the connecting pipe 8 (see FIG. 1). The large inner diameter passage 317 allows communication between the small inner diameter passage 316 and a communication passage 383 that is formed in the axial part 38.

The valve body 36 comprises a valve part 37, the axial part 38, and the like. The valve body 36 is inserted into the through hole 215 of the first housing 21, and is disposed to be movable in a shuttling manner along a φ direction which is an axis of the valve 1. The valve body 36 may be movable in mutually-opposing directions, for example. The valve body 36 may be a “movable valve body” in the claims.

The valve part 37 is formed substantially in a column shape, and is housed in the first housing 21. The valve part 37, which may be a “first end” of a valve body in the claims, is formed to have its outer diameter being smaller than the inner diameter of the first pressure chamber 251. Therefore, a gap is defined between an inner wall of the first pressure chamber 251 and an outer wall of the valve part 37 which is on the outer perimeter thereof. A first concave portion 371 is formed on a first cover 26 side outer wall of the valve part 37. In the first concave portion 371, a contact member 374 is disposed. The contact member 374 may be made of a resin material and have a ring shape. The contact member 374 may abut the conical surface 267 of the first cover 26. The contact member 374 is formed so that a seat diameter of the member 374, which abuts the conical surface 267 of the first cover 26, has the same diameter as a seal diameter of the sealing member 216.

A second concave portion 372 is formed on a second cover 31 side outer wall of the valve part 37. The second concave portion 372 has a threaded groove formed on its inner wall. An end part 381 of the axial part 38 is inserted into the second concave portion 372.

The valve part 37 has a communication passage 373 formed along a φ direction, which is an axis of the valve 1. The communication passage 373 allows communication between the first concave portion 371 and the second concave portion 372.

The axial part 38 is formed in a cylindrical shape. The communication passage 383 is bored substantially at the center of a φ direction facing surface of the axial part 38, which may be a “second end” of the valve body in the claims.” Therefore, the first pressure chamber 251 and the fourth pressure chamber 254 are communicable via the first concave portion 371, the communication passage 373, the second concave portion 372, and the communication passage 383.

The axial part 38 has the threaded groove formed on the outer walls on both ends thereof in the radial direction. The threaded groove on the side closer to the end part 381 engages the threaded groove on an inside of the second concave portion 372 of the valve part 37, with an adhesive. In such manner, airtightness is maintained between the first pressure chamber 251 and the communication passage 383. Further, the threaded groove on the side closer to an end part 382 engages with the sliding part 39, with an adhesive. In such manner, airtightness is maintained between the third pressure chamber 253 and the communication passage 383.

The sliding part 39 is housed in the second housing 22. The sliding part 39 is formed as a one-body combination of a cylinder part 391, a bottom 392, and a projected part 393.

The cylinder part 391 is formed in the shape of cylinder, and has a sealing member 394 disposed on its outer wall, which is on an outside in the radial direction. The sealing member 394, which may be a “third seal” in the claims, is an O-ring, for example, and it is disposed thereon to be slidable against an inner wall of the second housing 22, maintaining airtightness between the third pressure chamber 253 and the fourth pressure chamber 254. The bottom 392 is formed in a ring shape, and is connected to a second cover 31 side of the cylinder part 391. The cylinder part 391 and the bottom 392 may be a “second pressure receiver” and a “partition portion” in the claims.

The projected part 393 is formed in the shape of a cylinder with its outer diameter being smaller than an outer diameter of the cylinder part 391, and is inserted into the large inner diameter passage 317 of the second cover 31. An outer wall 396 on an outer perimeter of the projected part 393 has a sealing member 397 disposed thereon. The sealing member 397, which may be a “second seal” in the claims, is disposed thereon to be slidable against an inner wall that defines the large inner diameter passage 317, maintaining airtightness between the fourth pressure chamber 254 and the large inner diameter passage 317. The sealing member 397 has a seal diameter that is smaller than a seal diameter of the sealing member 394 of the cylinder part 391. The projected part 393 may be a “first pressure receiver” and a “supporter” in the claims. Therefore, a size of a pressure receiving area of the first pressure receiver is smaller than a size of a pressure receiving area of the second pressure receiver.

A through hole 395 is bored substantially at the center of the bottom 392 and the projected part 393. The threaded groove to be engaged with a threaded groove on the other one of the end part 382 of the axial part 38 is formed on an inner wall of the through hole 395.

The main spring 41 is housed in the third pressure chamber 253. The main spring 41 has one end fastened to a surface 398 of the bottom 392 to which the axial part 38 is connected, and has its other end fastened to the surface 219 of the flange 213 of the first housing 21. As such, at least a portion of the main spring 41 is positioned at the first end of the valve body. The main spring 41, which may be a “first biasing member” in the claims, biases the valve body 36 away from the conical surface 267.

The biasing force adjuster 51 is formed in the through hole 268 of the first cover 26 and includes a linear mover 52 and a rotary mover 53. The biasing force adjuster 51 changes a set length of the sub-spring 54.

The linear mover 52 changes its relative position along the φ direction, (i.e., along the axis of the valve 1), relative to the first cover 26 by rotating against the first cover 26. On one side of the linear mover 52 closer to the valve body 36, a threaded groove is formed on an outer wall, which is on an outer perimeter thereof. The linear mover 52 is connected to the rotary mover 53 via the threaded groove.

The rotary mover 53 is formed substantially in a cylindrical shape, and the end of the linear mover 52 closer to the valve body 36 is inserted into a substantially center part of the rotary mover 53. The rotary mover 53 allows a free rotation of the linear mover 52. The sub-spring 54 is positioned between the rotary mover 53 and the valve body 36.

The sub-spring 54 has one end fastened to one end of the rotary mover 53 that is closer to the valve body 36, and has its other end fastened to an inside of the first concave portion 371 of the valve body 36. The sub-spring 54, which may be a “second biasing member” in the claims, biases the valve body 36 away from the conical surface 267 (i.e., in a valve opening direction).

An operation of the pressure control valve 1 in the first embodiment is described.

When the engine 19 is stopped, the pressure of the gaseous fuel of the large inner diameter passage 317 and the small inner diameter passage 316 of the pressure control valve 1, which are connected to the connecting pipe 8, is relatively high, because the injector 17 does not output the gaseous fuel from the connecting pipe 8. At such time, the valve body 36 acts against a biasing force of the main spring 41, and moves in a direction of the conical surface 267, thereby the conical surface 267 of the valve part 37 to abut the contact member 374. When the contact member 374 abuts the conical surface 267, the second pressure chamber 252 is formed as a space within a seat diameter of the contact member 374 of the valve body 36, with which a portion of the valve body 36 abuts the conical surface 267, as shown in FIG. 3.

When the injector 17 injects the gaseous fuel into the intake manifold 18 while the engine 19 is operating, the pressure of the gaseous fuel in the large inner diameter passage 317 and the small inner diameter passage 316 decreases. If the pressure in the large inner diameter passage 317 decreases to less than a predetermined value, as shown in FIG. 2, the contact member 374 departs from the conical surface 267, and the gaseous fuel in the first pressure chamber 251 flows into the large inner diameter passage 317 through the communication passages 373 and 383. At such time, the size of an opening area between the contact member 374 and the conical surface 267 is adjusted, and the high-pressure gaseous fuel in the fuel tank 12 is controlled to have a low pressure which can be injected from the injector 17.

Here, the magnitude of the output pressure of the gaseous fuel at a time of output from the pressure control valve 1 for gaseous to the injector 17 is described.

As shown in FIG. 3, a diameter of the valve part 37 is designated as d1 (m), a seat diameter of the contact member 374 with which the contact member 374 abuts on the conical surface 267 as d2 (m), a seal diameter of the sealing member 216 disposed on the through hole 215 of the bottom 212 as d3 (m), an inner diameter of the communication passage 383 as d4 (m), a seal diameter of the sealing member 394 as d5 (m), and a seal diameter of the sealing member 397 as d6 (m). An input pressure of the gaseous fuel supplied from the inlet port 214 to the first pressure chamber 251 that is formed on an outer perimeter of the seat diameter d2 of the contact member 374 is designated as Pin (Pa), an output pressure of the gaseous fuel outputted from the large inner diameter passage 317 via the small inner diameter passage 316 as Pout (Pa), an intake manifold pressure which is a pressure of a gas in the intake manifold 18 to be introduced into the third pressure chamber 253 as Pm (Pa), and a total biasing force which is a sum of a biasing force of the main spring 41 and a biasing force of the sub-spring 54 as Fset1 (N). A first applied force F1 which is applied to the valve body 36 in a valve opening direction, causing a departure of the contact member 374 from the conical surface 267 (i.e., the contact member 374 moves away from the conical surface 267), is expressed by the following Equation 1.

$$F 1 = \{ π \times ( d {1}^{2} - d {2}^{2} ) \times Pin \} / 4 + \{ π \times ( d {2}^{2} - d {4}^{2} ) \times Pout \} / 4 + \{ π \times ( d {5}^{2} - d {3}^{2} ) \times Pm \} / 4 + Fset 1 \qquad Equation 1$$

In the pressure control valve 1 of the first embodiment, the seat diameter d2 with which the contact member 374 of the valve body 36 abuts on the conical surface 267 is the same as the seal diameter d3 of the sealing member 216 as described above. The seat diameter d2 may be a “first diameter” in the claims. The seal diameter d5 may be a “second diameter” in the claims. The seal diameter d6 may be a “third diameter” in the claims. Further, a term {π×(d5²−d3²)×Pm}/4 in the Equation 1 may be a “second received force” in the claims.

A second applied force F2 which is applied to the valve body 36 in a valve closing direction, causing an abutment of the contact member 374 on the conical surface 267, is expressed with the following Equation 2.

$$F 2 = \{ π \times ( d {1}^{2} - d {3}^{2} ) \times Pin \} / 4 + \{ π \times ( d {6}^{2} - d {4}^{2} ) \times Pout \} / 4 \qquad Equation 2$$

A term {π×(d6²−d4²)×Pout}/4 in the Equation 2 may be a “first received force” in the claims.

A pressure of the gaseous fuel, which represents an amount of the gaseous fuel injected by the injector 17, is determined as a differential pressure. The differential pressure is a difference between the pressure of the gaseous fuel injected by the injector 17 into the intake manifold 18 (i.e., the output pressure Pout) and the intake manifold pressure 18 (i.e., the intake manifold pressure).

Based on the Equation 1 and the Equation 2, the pressure of the gaseous fuel injected by the injector 17 into the intake manifold 18 is expressed by the following Equation 3, in view of a relationship between the first applied force F1 and the second applied force F2.

Pout−Pm×{(d5²−d3²)/(d6²−d2²)}=(4^{×F}set1)/{π×(d6²−d2²)} Equation 3

Here, an assembly procedure for assembling the pressure control valve 1 is described with reference to FIG. 2.

First, the sliding part 39 and the main spring 41 are inserted into the second housing 22 from a left-hand side of FIG. 2. Next, the first housing 21 is inserted into the second housing 22 from a left-hand side of FIG. 2, and the first housing 21 and the second housing 22 are combined by using screws. At such moment, the main spring 41 with one end fastened on the surface 219 of the flange 213 biases the sliding part 39 toward a right-hand side of FIG. 2. However, the movement of the sliding part 39 toward the right-hand side of FIG. 2 is restricted by the stepped surface 223 of the second housing 22.

Next, the axial part 38 is inserted into the through hole 215, and the axial part 38 and the sliding part 39 are combined by using screws and an adhesive. Then, the valve part 37 is attached to the end part 381 of the axial part 38, and the first cover 26 is attached to the first housing 21 together with the sub-spring 54 and the biasing force adjuster 51.

Lastly, the second cover 31 and the second housing 22 are combined by screwing the threaded groove of the second cover 31 to the threaded groove of the second housing 22. In such manner, the pressure control valve 1 is assembled.

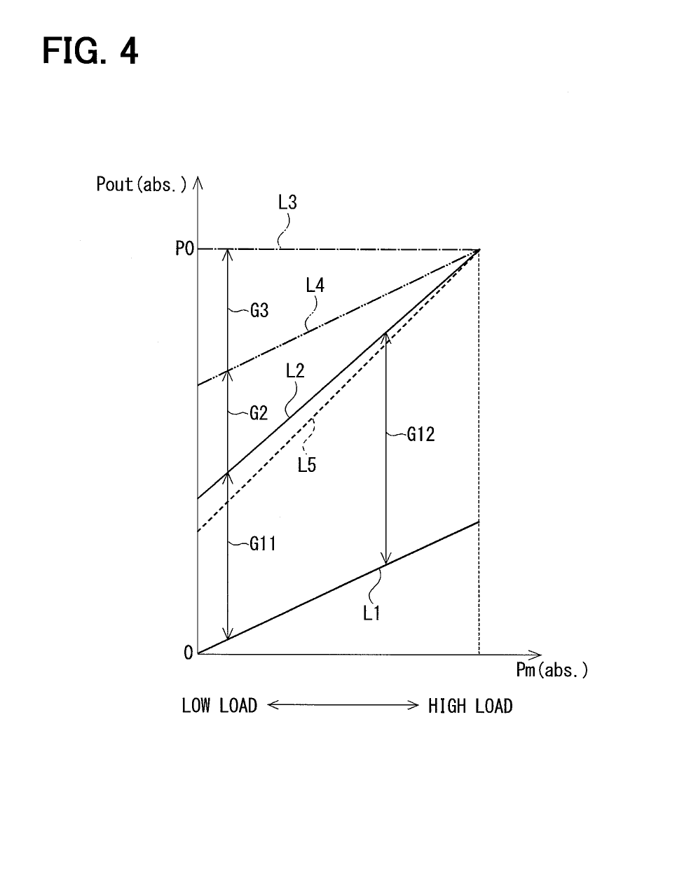

(1) In the pressure control valve 1 in the first embodiment, the differential pressure across the output pressure Pout of the gaseous fuel outputted to the injector 17 and the intake manifold pressure Pm in the intake manifold 18 can be changed according to the magnitude of the intake manifold pressure Pm. The operation of the valve 1 and the effects achieved by such operation are described with reference to FIG. 4.

FIG. 4 illustrates the relationship between the intake manifold pressure Pm in the intake manifold 18 and the output pressure Pout of the gaseous fuel which is output from the pressure control valve 1. In FIG. 4, the intake manifold pressure Pm is taken along the horizontal axis, and the output pressure Pout is taken along the vertical axis.

In FIG. 4, a solid line L1 shows change of the intake manifold pressure Pm, and a solid line L2 shows the relationship between the output pressure Pout and the intake manifold pressure Pm in the pressure control valve 1. Further, as a first comparative example, a dashed line L3 is used to show a relationship between the output pressure Pout and the intake manifold pressure Pm in a pressure control valve for gaseous fuel which is configured to output the gaseous fuel at a constant output pressure P0 regardless of the magnitude of the intake manifold pressure Pm. Further, as a second comparative example, a two-dot chain line L4 is used to show a relationship between the output pressure Pout and the intake manifold pressure Pm in a pressure control valve for gaseous fuel which is configured to output the gaseous fuel at an output pressure Pout so that a differential pressure across the output pressure Pout and the intake manifold pressure Pm has a constant value.

While the engine 19 is operating, the intake manifold pressure Pm changes according to the load of the engine 19. More practically, as shown by the solid line L1 in FIG. 4, the intake manifold pressure Pm at a low load time is observed as a relatively large negative pressure. That is, Pm has a small absolute value and the intake manifold pressure Pm at a high load time is observed as a relatively small negative pressure (i.e., Pm has a large absolute value). Therefore, for example, the intake manifold pressure Pm at a throttle valve full open time is 0 (Mpa) as a gauge pressure, that is, the absolute value of pressure is 0.1013 (Mpa).

In the pressure control valve for gaseous fuel of the first comparative example, as shown by the dashed-dotted line L3 in FIG. 4, the gaseous fuel is output, regardless of the magnitude of the intake manifold pressure Pm, at a constant output pressure P0 by the pressure control valve for gaseous fuel in the first comparative example. Therefore, the differential pressure across the intake manifold pressure Pm and the output pressure Pout increases, particularly at low load of the engine 19 (see a differential pressure G3 in FIG. 4). Thus, in the pressure control valve for gaseous fuel in the first comparative example, the injector for gaseous fuel injects the gaseous fuel in a short time (i.e., quickly) when the engine load is low.

In terms of injection characteristics of the injector for gaseous fuel, since the gaseous fuel injected by the injector has a small calorific value per unit volume in comparison to a liquid fuel, a volume of the gaseous fuel injected by the injector at one fuel injection time is larger than a volume of the liquid fuel injected by an injector for liquid fuel. For such reason, the injector has a relatively large valve body, which leads to a deteriorated responsiveness relative to the injector for liquid fuel. In other words, in comparison to the injector for liquid fuel, the injector has a narrower dynamic range, in which a stable relationship between the injection pulse width and the injection amount of the gas is observed. Therefore, in the pressure control valve for gaseous fuel of the first comparative example, when the engine load is low, the injector may possibly be operated outside of such dynamic range, which may result in an unstable injection amount of the gaseous fuel injected from the injector for gaseous fuel.

Further, in the pressure control valve for gaseous fuel of the second comparative example, the gaseous fuel is outputted at the output pressure Pout so that the differential pressure across the output pressure Pout and the intake manifold pressure Pm has a constant value. As shown by the two-point chain line L4 in FIG. 4, in the pressure control valve for gaseous fuel of the second comparative example, a differential pressure G2 is constant irrespective of the magnitude of the engine load. Therefore, the pressure control valve for gaseous fuel in the second comparative example does not easily become unstable in terms of the injection amount of the gaseous fuel at the high/low load time of the engine 19 in comparison to the pressure control valve for gaseous fuel in the first comparative example. However, when the engine load is extremely low or high, that is, depending on the engine operation environment or depending on a specification of the engine, the injection amount of the gaseous fuel injected from the injector for gaseous fuel may possibly become unstable.

In the pressure control valve 1 of the first embodiment, the pressure of the gaseous fuel supplied to the intake manifold 18 (i.e., the injected amount of gaseous fuel), is computed by the Equation 3 which is drawn from a relation between the first applied force F1 and the second applied force F2 which are applied to the valve body 36. In other words, the first applied force F1 and the second applied force F2 may be respectively applied to the valve body to move the valve body in mutually-opposing directions. The left-hand side of the Equation 3 is a value which is a result of subtracting a product of the intake manifold pressure and a change factor CF, that is, a term {(d5²−d3²)/(d6²−d2²)} subtracted from the output pressure Pout.

According to the Equation 3, as shown by the solid line L2 in FIG. 4, when the load of the engine 19 is low, that is, when the absolute value of the intake manifold pressure Pm is small, the differential pressure across the output pressure Pout and the intake manifold pressure Pm becomes relatively small (i.e., see a differential pressure G11 in FIG. 4), and the amount of the gaseous fuel injected within a single injection period decreases. Therefore, by the fuel injection in an operation area in which an injection pulse width that is inputted to the injector 17 is small, only a small amount of the gaseous fuel is injected within the single injection period, and, due to the short injection pulse width, the gaseous fuel is injected by a suitable amount which is suitably adjusted to the engine load. In other words, the valve body decreases the differential pressure when the absolute value of the intake manifold pressure is small. Further, when the load of the engine 19 is high (i.e., when the absolute value of the intake manifold pressure Pm is large), the differential pressure across the output pressure Pout and the intake manifold pressure Pm becomes relatively large (i.e., see a differential pressure G12 in FIG. 4), and the amount of the gaseous fuel injected within the single injection period increases. Therefore, by the fuel injection in an operation area in which an injection pulse width that is inputted to the injector 17 is large, a large amount of the gaseous fuel is injected within the single injection period, and, due to the wide injection pulse width, the gaseous fuel is injected by a suitable amount which is suitably adjusted to the engine load. In other words, the valve body increases the differential pressure when an absolute value of the intake manifold pressure is large.

Thus, the pressure control valve 1 supplies the gaseous fuel having the output pressure Pout, which is determined according to the magnitude of the intake manifold pressure Pm, to the injector 17 which has a relatively narrow dynamic range, and such configuration enables a widening of the dynamic range of a gaseous fuel supply system, including the injector for gaseous fuel. Therefore, the pressure control valve 1 in the first embodiment provides an improved stability of injection for a gaseous fuel supply system.

(2) Further, in the pressure control valve 1 in the first embodiment, without having an electromagnetic actuator which has an expensive and complicated configuration, the output pressure P is determined and output according to the magnitude of the intake manifold pressure Pm, and such pressure is supplied to the injector 17. Therefore, such configuration of the pressure control valve 1 is simplified, and the volume of the pressure control valve 1 is reduced.

(3) The change factor CF of the Equation 3 includes the seat diameter d2 with which the contact member 374 abuts the conical surface 267, the seal diameter d3 of the sealing member 216, the seal diameter d5 of the sealing member 394, and the seal diameter d6 of the sealing member 397. Especially, the seal diameter d6 of the sealing member 397 contained in the change factor CF is changeable by changing the sizes of the projected part 393, the second cover 31, and the sealing member 397. Therefore, the magnitude of the differential pressure across the output pressure Pout and the intake manifold pressure Pm which is changed according to the magnitude of the intake manifold pressure Pm can be changed by changing the sizes of these components. In other words, by changing only a few components, the change slope of the differential pressure across the output pressure Pout and the intake manifold pressure Pm, which is determined according to the change of the intake manifold pressure Pm, can be changed from the solid line L2 to a dotted line L5 in FIG. 4, for example. In such manner, without preparing an injector for gaseous fuel which has an adjusted dynamic range according to an engine specification, for example, a suitable gaseous fuel supply system is set up, which is suitably adjusted to a specification-changed engine, only by changing a few components in the gaseous fuel pressure control valve.

(4) Further, the pressure control valve 1 has the biasing force adjuster 51 in which the sub-spring 54 having an adjustable set length is provided. Therefore, a total biasing force Fset1, which is a sum of the biasing force of the main spring 41 and the biasing force of the sub-spring 54 in the Equation 3, is changeable by an easy operation, thereby enabling a change of the differential pressure across the output pressure Pout and the intake manifold pressure Pm for the same intake manifold pressure Pm.

### Second Embodiment

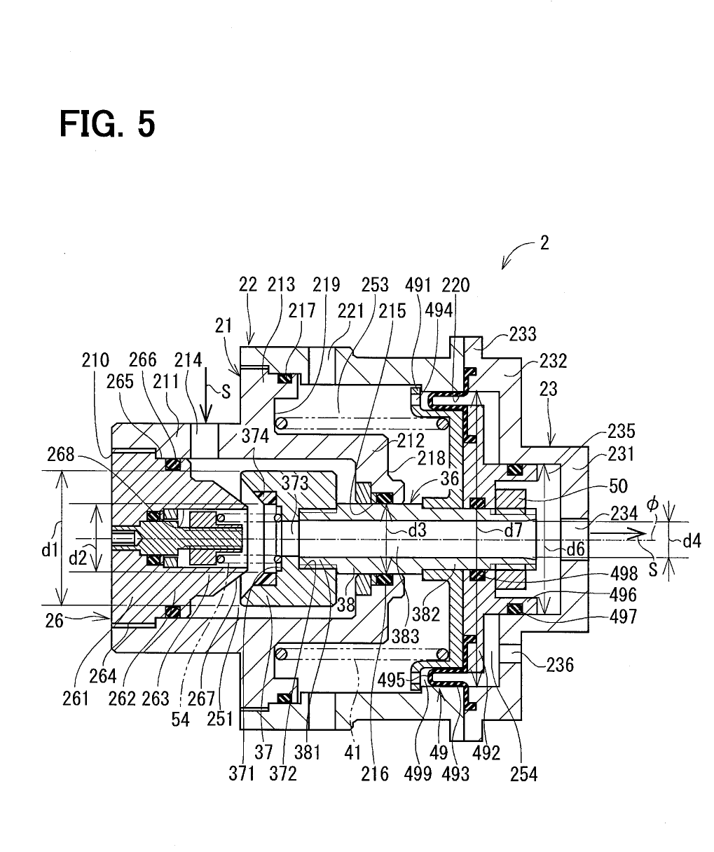

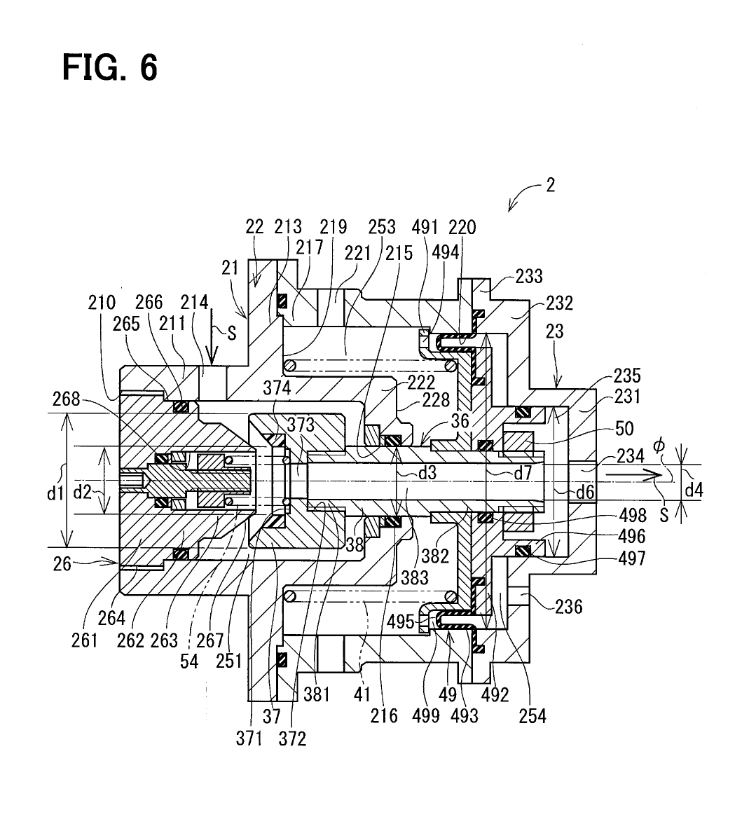

The second embodiment of the present disclosure, another pressure control valve for gaseous fuel by is described with reference to FIGS. 5 and 6. In the second embodiment, a pressure receiving part for receiving the output pressure and the intake manifold pressure is different from the first embodiment. Like parts have like numbers in the first and second embodiments, for the brevity and consistency of the description. An arrow S in FIG. 5 and FIG. 6 indicates a flow direction of the gaseous fuel.

In addition to the first housing 21 and the second housing 22, a third housing 23 is provided for a pressure control valve 2 for gaseous fuel in the second embodiment.

The third housing 23 is disposed on the opposite side of the first housing 21 relative to the second housing 22. The third housing 23 is disposed to cover the opening 220 of the second housing 22. The third housing 23 is a one body combination of a concave portion 231 in the shape of a cylinder having a bottom, a ring part 232 connected to the concave portion 231, and a flange 233 connected to the ring part 232. The third housing 23 may be a “housing” in the claims.

The concave portion 231 is disposed at a position which is most distant from the second housing 22, as shown in FIG. 5. A through hole 234 is bored substantially at the center of the concave portion 231. The through hole 234 allows communication between an outlet chamber 235, which is an inside of the concave portion 231, and the injector 17. The through hole 234 and the outlet chamber 235 may be an “inlet port” in the claims.

The ring part 232 extending from a periphery of an opening of the concave portion 231 extends substantially perpendicularly to a center axis of the valve 2. The fourth pressure chamber 254 is defined by the ring part 232, together with a supporter 492 and a diaphragm 493 of a diaphragm part 49, which are mentioned later. The ring part 232 has a communication hole 236 bored therethrough which allows communication between the fourth pressure chamber 254 and the atmosphere.

The flange 233 is connected to a periphery on the radial outside of the ring part 232. The flange 233 is connected by bolts (not illustrated) to the periphery of the second housing 22 which forms the opening 220. The flange 233 supports a periphery on the radial outside of the diaphragm 493 together with the second housing 22.

In the pressure control valve 2 for gaseous fuel of the second embodiment, the diaphragm part 49 replaces the sliding part 39 of the first embodiment. The diaphragm part 49 maintains airtightness between the third pressure chamber 253 and the fourth pressure chamber 254 by connecting to the axial part 38 and sliding on the inner wall of the second housing 22. The diaphragm part 49 includes supporters 491 and 492, a diaphragm 493, together with other parts.

The supporter 491 is a ring part disposed on a valve part 37 side of the diaphragm part 49. A through hole is bored substantially at the center of the supporter 491, and the end part 382 of the axial part 38 is inserted into the through hole. On one surface of the supporter 491 facing the valve part 37, one end of the main spring 41 is fastened. Further, a periphery portion of the supporter 491 has a through hole 494 bored thereon. The through hole 494 allows communication between the third pressure chamber 253 and an open space 499 between the supporter 491 and the diaphragm 493. The supporter 491 may be a “second pressure receiver” and a “partition portion” in the claims.

The supporter 492 is disposed on the opposite side of the supporter 491 relative to the diaphragm 493. A through hole is bored substantially at the center of the supporter 492, and the end part 382 of the axial part 38 is inserted into the through hole. The supporter 491 and the supporter 492 are fixed onto the end part 382 of the axial part 38 by using a fastener 50, into which the axial part 38 is also inserted. Further, on one side of the supporter 492 closer to the concave portion 231, a projected part 496 projecting to fit into the concave portion 231 is formed. On the radial outside of the projected part 496, a sealing member 497 maintaining airtightness between the fourth pressure chamber 254 and the outlet chamber 235 is disposed, which may be a “second seal” in the claims. On the inner wall of the through hole into which the end part 382 of the axial part 38 is inserted, a sealing member 498 maintaining airtightness between the third pressure chamber 253 and the outlet chamber 235 is formed. The projected part 496 may be a “first pressure receiver” and a “supporter” in the claims.

The diaphragm 493 is, for example, a rolling diaphragm, which is made of rubber. The diaphragm 493 has a radial inside periphery portion supported by the supporters 491 and 492 in a binding/sandwiching manner, and has an outer perimeter periphery portion supported by the second housing 22 and the third housing 23. A pressure of a gas in the intake manifold 18 is applied to a surface 495 of the diaphragm 493 facing the valve part 37, which is to be introduced into the third pressure chamber 253. The diaphragm 493 may be a “second pressure receiver” and a “third seal” in the claims.

In the pressure control valve 2 for gaseous fuel of the second embodiment, the valve body 36 is driven with airtightness between the third pressure chamber 253 and the fourth pressure chamber 254 being maintained by using the diaphragm part 49, instead of using the sealing member 394 of the first embodiment. At such time, the intake manifold pressure Pm of the third pressure chamber 253 and the output pressure Pout of the outlet chamber 235 are both applied to the diaphragm part 49.

If an effective diameter of the diaphragm 493 is designated as d7 (m) as shown in FIG. 5, the pressure of the gaseous fuel injected by the injector 17 into the intake manifold 18 is, based on a relationship between an applied force which is applied to the valve body 36 in a valve opening direction and an applied force which is applied to the valve body 36 in a valve closing direction (e.g. the first applied forces may be respectively applied to the movable valve body to move the valve body in mutually-opposing directions), expressed by the following Equation 4, just like the Equation 3 in the first embodiment.

Pout−Pm×{(d7²−d3²)/(d6²−d2²)}=(4×Fset1)/{π×(d6²−d2²)} Equation 4

Therefore, the pressure control valve 2 for gaseous fuel exerts the same effects as the first embodiment.

Further, in the pressure control valve 2 for gaseous fuel in the second embodiment, as described above, the valve body 36 is driven with the diaphragm part 49 to maintain airtightness between the third pressure chamber 253 and the fourth pressure chamber 254, instead of the sealing member 394, which maintains airtightness of the third pressure chamber 253 and the fourth pressure chamber 254 sliding on the wall of the second housing 22. Therefore, the sliding resistance in the course of controlling a pressure is reduced, in comparison to the pressure control valve 1 in the first embodiment. That is, in addition to the advantageous effects in the first embodiment, the pressure control valve 2 for gaseous fuel in the second embodiment reduces hysteresis for controlling the pressure of gaseous fuel.

A modification of the pressure control valve 2 for gaseous fuel in the second embodiment is shown in FIG. 6.

In the modification of the pressure control valve 2 for gaseous fuel shown in FIG. 6, both of the flange 213 of the first housing 21 and one end of the first housing 21 closer to the second housing 22 have a flange shape. In the present modification, the first housing 21 and the second housing 22 are connected by using bolts (not shown) or the like. In such manner, there is no need for the first and second housings 21, 22 to be rotated relative to each other in the course of assembly, which causes twisting of the main spring 41. That is, when one end of which is fastened on the surface of the supporter 491 facing the first housing 21 and the other end of which is fastened on the surface 219 of the flange 213 of the first housing 21, twisting of the first housing 21 relative to the second housing 22 leads to breakage of the main spring 41. Therefore, in addition to the above-described hysteresis reduction capability in the course of pressure control and the advantageous effects in the first embodiment, in the modification of the pressure control valve 2 for gaseous fuel of the second embodiment, breakage of the main spring 41 by the twisting is prevented.

### Third Embodiment

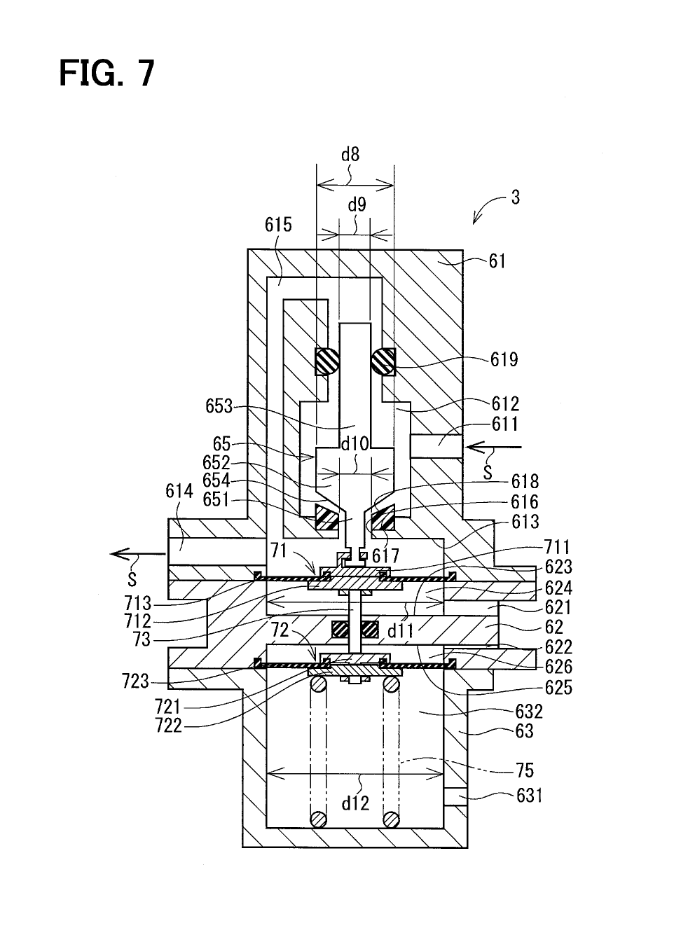

The third embodiment of the present disclosure regarding a pressure control valve 3 for gaseous fuel is described with reference to FIG. 7. The main difference of the third embodiment from the first embodiment is that the valve 3 in the present embodiment has two diaphragms. An arrow S in FIG. 7 indicates a flow direction of the gaseous fuel.

The pressure control valve 3 for gaseous fuel in the third embodiment is a so-called poppet type valve. The pressure control valve 3 for gaseous fuel includes a first housing 61, a second housing 62, a third housing 63, a valve body 65, a first diaphragm part 71, a second diaphragm part 72, together with other parts.

The first housing 61 is formed substantially in the shape of a column. An inlet port 611 is formed on the side wall on the radial outside of the first housing 61. An outlet port 614 is formed on a side wall on an opposite side, which is opposite to the inlet port 611. The inlet port 611 is connected to the fuel tank 12 via the connecting pipe 7. The outlet port 614 is connected to the injector 17 via the connecting pipe 8. In an inside of the first housing 61, a first housing concave portion 613, an inside of which communicates with the outlet port 614, and a first pressure chamber 612 that allows communication between the inlet port 611 and the inside of the first housing concave portion 613 via a through hole 616 are formed. Further, an inside of the first housing concave portion 613 and the first pressure chamber 612 communicate with each other also via a communication passage 615 that is formed in the first housing 61.

The second housing 62 is formed on one side of the first housing 61 closer to the first housing concave portion 613. The second housing 62, together with the first housing 61, supports a periphery portion on the radial outside of the first diaphragm part 71. Further, the second housing 62, together with the third housing 63, supports a periphery portion on the radial outside of the second diaphragm part 72. Two through holes 621 and 622 are bored at radial outside positions on the second housing 62. The through hole 621 communicates with a first manifold chamber 624 that is defined by (i) a second housing first concave portion 623 that is formed on one side of the second housing 62 closer to the first housing 61 and (ii) the first diaphragm part 71. The first manifold chamber 624 is formed so that an inner diameter thereof is configured to be same as the inner diameter of the first housing concave portion 613 of the first housing 61, and the gas of the intake manifold 18 is introduced into the first manifold chamber 624. The through hole 622 communicates with an atmospheric chamber 626, which is defined by a second housing second concave portion 625 that is formed on one side of the second housing 62 closer to the third housing 63 and the second diaphragm part 72. The atmosphere is introduced into the atmospheric chamber 626.

The third housing 63 is disposed on a second housing first concave portion 623 side of the second housing 62. A main spring 75 is housed in an inside of the third housing 63. A through hole 631 is bored on a side wall on the radial outside of the third housing 63. The through hole 631 communicates with a second manifold chamber 632 that is defined by an inner wall of the third housing 63 and the second diaphragm part 72. The second manifold chamber 632 is formed so that the inner diameter of the second manifold chamber 632 is configured to be same as the inner diameter of the first manifold chamber 624, and the gas in the intake manifold 18 is introduced into the second manifold chamber 632 via the connecting pipe 181.

The valve body 65 is housed in the first housing 21, with its shuttling movement freely allowed therein. The valve body 65 includes a first axis part 651, a valve part 652, and a second axis part 653 together with other parts. The valve body 65 interrupts or allows communication between the first pressure chamber 612 and the outlet port 614 by abutting on or departing from a seat member 617.

The first axis part 651 is formed in a column shape, and is inserted into the through hole 616 which allows communication between the first pressure chamber 612 and an inside of the first housing concave portion 613. One end of the first axis part 651 is connected to the first diaphragm part 71.

The valve part 652 is formed in the shape of a truncated cone which has a larger outer diameter than the outer diameters of the first axis part 651 and the second axis part 652, and is connected to the other end of the first axis part 651. A conical surface 654 formed in a slanted manner against a moving direction of the valve body 65 is capable of abutting on a slope 618, which may be a “valve seat” in the claims, of the seat member 617 that is provided on the inner wall of the first pressure chamber 612 and is made of resin.

One end of the second axis part 653 is connected to one end of the valve part 652, which is an opposite end to a conical surface end of the valve part 652 having the conical surface 654 formed thereon. The other end of the second axis part 653 has, on its radial outside, a sealing member 619 disposed thereon. The sealing member 619 maintains airtightness between the first pressure chamber 612 and the communication passage 615. In the pressure control valve 3 for gaseous fuel in the third embodiment, the other end of the second axis part 653 is configured to have the following dimension. That is, a seal diameter of the sealing member 619 has the same size as a seat diameter of the valve body 65, with which the conical surface 654 of the valve body 65 abuts on the slope 618.

The first diaphragm part 71 includes two supporters 711 and 712, a first diaphragm 713, together with other parts. The first diaphragm part 71 may be a “first pressure receiver” and a “second pressure receiver” in the claims.

The supporter 711 is formed on one side of the first diaphragm 713 closer to the first housing 61, and is connected to one end of the first axis part 651. The supporter 712 is formed on a second housing 62 side of the first diaphragm 713, and is connected to one end 731 of a connecting shaft 73.

The first diaphragm 713 is supported by the supporters 711 and 712 on its periphery portion which is on the radius inside thereof. The first diaphragm 713 moves in an axial direction according to a difference of magnitudes between a pressure of a gas in an inside of the first housing concave portion 613 and a pressure of a gas in the first manifold chamber 624, which makes the conical surface 654 of the valve body 65 either abut on or move away from the slope 618 of the seat member 617.

The second diaphragm part 72 includes two supporters 721, 722 and a second diaphragm 723, together with other parts. The second diaphragm part 72 may be a “second pressure receiver” in the claims.

The supporter 721 is formed on one side (i.e., a second housing 62 side) of the second diaphragm 723, and is connected to an end 732 of the connecting shaft 73. Further, the supporter 722 is formed one side (i.e., a third housing 63 side) of the second diaphragm 723, and has an end of a main spring 75 fastened thereon. The second diaphragm 723 is supported by the supporters 721, 722 on an inner periphery portion. The second diaphragm 723 moves in an axial direction according a difference of magnitudes between a pressure of a gas in the atmospheric chamber 626 and a pressure of a gas in the second manifold chamber 632, and, having the connecting shaft 73 interposed therebetween, the second diaphragm 723 makes the conical surface 654 of the valve body 65 either abut on or depart from the slope 618 of the seat member 617. In the pressure control valve 3 for gaseous fuel in the third embodiment, an inner diameter of the second manifold chamber 632 has the same size as an inner diameter of the first manifold chamber 624.

The connecting shaft 73 is a rod-shape member positioned between the supporter 712 of the first diaphragm part 71 and the supporter 721 of the second diaphragm part 72. The connecting shaft 73 transfers an axial movement of the second diaphragm 723 to the first diaphragm part 71 and to the valve body 65.

The main spring 75 has its one end fastened to an inner wall of the third housing 63. The main spring 75 biases the second diaphragm part 72 in a direction of the valve body 65 (i.e., a direction in which the conical surface 654 of the valve body 65 departs from the slope 618 of the seat member 617).

An operation of the pressure control valve 3 for gaseous fuel in the third embodiment is described in the following.

When the engine 19 is stopped, the valve body 65 acts against a biasing force of the main spring 75 and moves in a direction of the seat member 617, thereby causing an abutment of the conical surface 654 of the valve body 65 on the slope 618 of the seat member 617.

If the injector 17 injects the gaseous fuel into the intake manifold 18 while the engine 19 is operating, the pressure of the gaseous fuel in an inside of the outlet port 614 and the first housing concave portion 613 decreases. When the pressure of the gaseous fuel in an inside of the first housing concave portion 613 falls to be lower than a predetermined value, the conical surface 654 of the valve body 65 departs from the slope 618, and the gaseous fuel in the first pressure chamber 612 flows into an inside of the first housing concave portion 613 through the through hole 616. At such time, the size of an opening between the conical surface 654 and the slope 618 is adjusted according to a magnitude of each of a pressure of the gaseous fuel in an inside of the first housing concave portion 613, a pressure in the first manifold chamber 624, a pressure in the second manifold chamber 632, and the like. Therefore, a pressure of the high-pressure gaseous fuel in the fuel tank 12 is adjusted to a lower level (i.e., to the low pressure which can be injected by the injector 17).

Here, the magnitude of the output pressure of the gaseous fuel which is output from the pressure control valve 3 for gaseous fuel to the injector 17 is described.

As shown in FIG. 7, when an outer diameter of the valve part 652 is designated as d8 (m), an outer diameter of the sealing member 619 is designated as d9 (m), a seat diameter with which the conical surface 654 of the valve body 65 abuts on the slope 618 is designated as d10 (m), an inner diameter of the first manifold chamber 624 is designated as d11 (m), and an inner diameter of the second manifold chamber 632 is designated as d12 (m). An input pressure of the gaseous fuel supplied to the first pressure chamber 612 via the inlet port 611 is designated as Pin (Pa), an output pressure of the gaseous fuel outputted from the outlet port 614 via the inside of the first housing concave portion 613 is designated as Pout (Pa), an intake manifold pressure which is a pressure of a gas in the intake manifold 18 to be introduced into the first manifold chamber 624 and into the second manifold chamber 632 is designated as Pm (Pa), and a biasing force of the main spring 75 is designated as Fset2 (N). A first applied force F3 that is applied to the valve body 65 in a valve opening direction, i.e., causing a departure of the conical surface 654 of the valve body 65 from the slope 618, is expressed by the following Equation 5.

$$F 3 = \{ π \times ( d {8}^{2} - d {10}^{2} ) \times Pin \} / 4 + ( π \times d {10}^{2} \times Pout ) / 4 + ( π \times d {11}^{2} \times Pm ) / 4 + ( π \times d {12}^{2} \times PM ) / 4 + Fset 2 \qquad Equation 5$$

A second applied force F4 that is applied to the valve body 65 in a direction which causes the conical surface 654 of the valve part 652 to abut on the slope 618 (i.e., a move in a valve closing direction), is expressed by the following Equation 6.

$$F 4 = ( π \times d {9}^{2} \times Pout ) / 4 + \{ π \times ( d {8}^{2} - d {9}^{2} ) \times Pin \} / 4 + ( π \times d {11}^{2} \times Pout ) / 4 \qquad Equation 6$$

The first applied force F3 and the second applied force F4 may be respectively applied to the movable valve body to move the valve body in mutually-opposing directions.

In the pressure control valve 3 for gaseous fuel in the third embodiment, as mentioned above, the seal diameter d9 of the sealing member 619 and the seat diameter d10 with which the conical surface 654 of the valve body 65 abuts the slope 618 are the same size. Further, the inner diameter d11 of the first manifold chamber 624 and the inner diameter d12 of the second manifold chamber 632 are also the same size. Therefore, the pressure of the gaseous fuel supplied from the injector 17 to the intake manifold 18 is expressed by the following Equation 7 based on the Equation 5 and the Equation 6 in view of a relationship between the first applied force F3 and the second applied force F4.

Pout−2×Pm=(4×Fset2)/(π×d11²) Equation 7

In the pressure control valve 3 for gaseous fuel in the third embodiment, the pressure of the gaseous fuel supplied to the intake manifold 18, that is, the amount of an injected gaseous fuel is calculated, according to the Equation 7, which is drawn from a relationship between the first applied force F3 and the second applied force F4 respectively applied to the valve body 65.

The left-hand side of the Equation 7 is a value which is a result of subtraction, that is, a two fold value of the intake manifold pressure Pm subtracted from the output pressure Pout, and, such a difference of two pressures (i.e., Pout−2 Pm) is changed/controlled according to the magnitude of the intake manifold pressure Pm, just like the first embodiment. Therefore, the pressure control valve 3 for gaseous fuel in the third embodiment provides the same effect as the effects (1) and (2) in the first embodiment.

### Other Embodiments

(a) According to the above-mentioned embodiment, (i) when the absolute value of the intake manifold pressure is large, the differential pressure across the output pressure and the intake manifold pressure is enlarged, and (ii) when the absolute value of the intake manifold pressure is small, the differential pressure across the output pressure and the intake manifold pressure is decreased.

However, the relationship between (A) the magnitude of the absolute value of the intake manifold pressure and (B) the differential pressure across the output pressure and the intake manifold pressure is not limited to the above.

(b) According to the above-mentioned first embodiment, the seal diameter of the sealing member of the projected part is defined as being smaller than the seal diameter of the sealing member of a cylinder part.

However, the magnitude relationship between the seal diameter of the sealing member of the projected part and the seal diameter of the sealing member of the cylinder part is not limited to the above.

(c) According to the above-mentioned first embodiment, the projected part, which may be a “first pressure receiver” in the claims, and the cylinder part and the bottom, which may be a second pressure receiver, are respectively formed in a piston shape. Further, according to the above-mentioned second embodiment, the projected part, which may be a “first pressure receiver” in the claims, is formed in a piston shape, and the supporter and the diaphragm, which may be a “second pressure receiver” in the claims, are formed in a diaphragm shape.

However, the shape of the first/second pressure receiver is not limited to the above. The first pressure receiver may be formed in a diaphragm shape.

(d) According to the above-mentioned third embodiment, the inner diameter of the first manifold chamber and the inner diameter of the second manifold chamber are defined as the same size.

However, the magnitude relationship between the inner diameter of the first manifold chamber and the inner diameter of the second manifold chamber is not limited to the above.

(e) According to the above-mentioned third embodiment, the first manifold chamber is defined as having the same inner diameter as the concave part of the first housing.

However, the magnitude of the inner diameter of the first manifold chamber is not limited to the above. The inner diameter of the first manifold chamber may be larger than the inner diameter of the concave part of the first housing, or may be smaller.

Although the present disclosure has been fully described in connection with preferred embodiment thereof with reference to the accompanying figures, it is to be noted that various changes and modifications will become apparent to those skilled in the art, and such changes, modifications, and summarized scheme are to be understood as being within the scope of the present disclosure as defined by appended claims.

What is claimed is:

1. A pressure control valve for a gaseous fuel supply system with a fuel tank for storing a gaseous fuel and an injector for injecting the gaseous fuel into an intake manifold that is connected to an internal-combustion engine, the pressure control valve comprising:
a housing having an inlet port and an outlet port, the inlet port through which the gaseous fuel is provided from the fuel tank and the outlet port through which pressure-controlled gaseous fuel is provided to the injector;
a first pressure receiver receiving a pressure provided to the injector;
a second pressure receiver receiving an intake manifold pressure;
a movable valve body that is positioned between the inlet port and the outlet port and biased by a first received force received by the first pressure receiver and a second received force received by the second pressure receiver; and
a seat member that selectively abuts the movable valve body to open and close communication between the inlet port and the outlet port, wherein the movable valve body changes a differential pressure between the pressure provided to the injector and the intake manifold pressure.

2. The pressure control valve of claim 1, wherein
the movable valve body increases the differential pressure when an absolute value of the intake manifold pressure is large, and
the movable valve body decreases the differential pressure when the absolute value of the intake manifold pressure is small.

3. The pressure control valve of claim 1, wherein
a size of a pressure receiving area of the first pressure receiver is smaller than a size of a pressure receiving area of the second pressure receiver.

4. The pressure control valve of claim 1, wherein
at least one of the first pressure receiver or the second pressure receiver is a diaphragm.

5. The pressure control valve of claim 1, wherein
at least one of the first pressure receiver or the second pressure receiver is a piston.

6. The pressure control valve of claim 1, wherein
the first received force and the second received force move the movable valve body in mutually-opposing directions.

7. A pressure control valve for a gaseous fuel supply system with a fuel tank for storing a gaseous fuel and an injector for injecting the gaseous fuel into an intake manifold that is connected to an internal-combustion engine, the pressure control valve comprising:
a housing having an inlet port and an outlet port, the inlet port providing the gaseous fuel from the fuel tank and the outlet port providing pressure-controlled gaseous fuel to the injector;
a movable valve body that is slidably disposed between the inlet port and the outlet port, and selectively provides a communication passage between the inlet port and the outlet port;
a seat member that selectively abuts the movable valve body to open and close the communication passage between the inlet port and the outlet port, the seat member that selectively abuts a first end of the movable valve body on a valve seat, and the valve seat having a seat diameter defined as a first diameter;
a first biasing member that biases the movable valve body in a direction that causes the movable valve body to move away from the seat member;
a first seal having a diameter equal to the first diameter to maintain airtightness between (i) a first pressure chamber positioned at a first end of the movable valve body, and (ii) a manifold chamber that houses the first biasing member and receives an intake manifold pressure;
a supporter connected to a second end of the movable valve body, the supporter having an outer diameter greater than the first diameter and slidably disposed to support a movement of the movable valve body;
a partition portion that separates an inside of the housing at a position between the supporter and the first seal, the partition portion having an outer diameter that is greater than an outer diameter of the supporter;
a second seal that is positioned on the supporter and has a seal diameter defined as a second diameter which is greater than the first diameter; and
a third seal that is positioned on the partition portion and has a seal diameter defined as a third diameter which is greater than the second diameter, wherein
the second seal maintains airtightness between (i) an atmospheric chamber that communicates with an atmosphere and is defined between the second seal and the third seal, and (ii) the outlet port, and
the third seal maintains airtightness between the manifold chamber and the atmospheric chamber.

8. The pressure control valve according to claim 7, wherein
at least one of the second seal or the third seal is an O-ring.

9. The pressure control valve according to claim 7, wherein
at least one of the second seal or the third seal is a diaphragm.

10. The pressure control valve of claim 7, wherein
at least a portion of the first biasing member is positioned at the first end of the movable valve body.

11. The pressure control valve of claim 7, further comprising:
a second biasing member that biases the movable valve body in a valve opening direction; and
a biasing force adjuster that adjusts a biasing force of the second biasing member.
